(19) United States
(12) Patent Application Publication
(10) Pub. No.: US 2019/0315158 A1
(43) Pub. Date: Oct. 17, 2019

(54) Wheel Spikes

(71) Applicant: Clarkson University, Potsdam, NY (US)

(72) Inventors: Gavin Hambrose, Medford, NJ (US); Brianna N. Doerfler, Windham, ME (US); Brian P. Chrzan, Clifton Park, NY (US); Taylor M. Fenoff, Ballston Spa, NY (US); Christopher L. Kudlacik, Glenville, NY (US); Katherine Slocum, Westborough, MA (US); Anthony Bertocchi, Washingtonville, NY (US); Brittany Hawley, Elm City, NC (US); Laurel Kuxhaus, Potsdam, NY (US)

(73) Assignee: Clarkson University, Potsdam, NY (US)

(21) Appl. No.: 16/383,131

(22) Filed: Apr. 12, 2019

Related U.S. Application Data
(60) Provisional application No. 62/656,570, filed on Apr. 12, 2018.

(51) Int. Cl. B60B 15/22; A61G 5/10

(52) U.S. Cl. CPC B60B 15/22; B60B 2900/551; B60B 2200/22; A61G 5/10

(57) ABSTRACT

A traction enhancement device and system for the rear wheel(s) of a wheelchair is provided. The traction enhancement system generally includes a tooth bar assembly that includes a plurality of spikes/teeth and an actuation assembly that includes a lever and swashplate. In use the lever can be moved into ground engaging position and the swashplate will contact and provide a force the tooth bar assembly causing the spikes to extend beyond the diameter of the wheelchair wheel and into engagement with the surface on which the chair is riding. The lever can be pulled out of ground engaging position and the swashplate will not cause the spikes to push outwardly beyond the diameter of the wheel.

### CROSS-REFERENCE TO RELATED APPLICATION

This application claims priority to U.S. Provisional Patent Application Ser. No. 62/656,570, filed on Apr. 12, 2018, and entitled “Wheel Spikes,” the entire disclosure of which is incorporated herein by reference.

### FIELD OF THE INVENTION

The present disclosure is directed generally to wheel chair wheels and more particularly to adaptive devices for such wheels that enhance traction.

### BACKGROUND

An estimated 3.55 million in the United States are wheelchair users. There are an additional 200,000 manual wheelchair users in Canada. Of these, an estimated 1.25 million people live and use manual wheelchairs in areas of North America that annually receive more than five inches of snow. Manual wheelchair users propel themselves forward and backwards using large rear wheels. On the front of the chair are smaller wheels (called casters) that rotate, providing stability and directional control. These small wheels are not well suited for environments that have rough terrains. The casters are susceptible to digging into soft ground and getting stuck on debris or uneven surfaces. Winter climates create an extra challenge due to the soft surfaces that snow creates and the uneven buildup of ice and salt.

The potential for wheelchair users to get stuck while attempting to maneuver through snowy and icy conditions is dangerous and discouraging for the individual to maintain their daily routine and lifestyle. While physical harm is a major concern, the effects that these dangerous conditions can have on the quality of life are substantial as well. A study from the Archives of Physical Medicine and Rehabilitation surveyed 99 residents in Canada that used wheeled mobility devices to determine what the users found as “the most salient environmental barriers to community participation during the winter”. From the survey, 95% reported problems with tires and casters becoming stuck in the snow, 92% reported difficulty with ramps and inclines, and 91% reported slipping on the ice. Sidewalks and roads were listed as challenging by 99% and 85% reported cold hands while using controls or pushing rims. The survey also showed that 42.4% indicated that they went outside less in winter months, greatly impacting the lifestyles of many.

As the study indicated, wheelchair users experience trouble navigating through winter conditions due to buildup of snow on the rear wheels and a lack of traction that is needed to effectively maneuver the wheelchair. The gap between the rear wheels and the rims also allows for snow and ice buildup to form as the chair travels through snow, which can cause difficulty moving or turning, decreased traction, and track melting ice and snow indoors. Users also must touch the cold snow while pushing the chair.

There are currently very few wheelchair products to aid in the mobility through snowy and icy conditions. There are devices designed for wheelchair travel over snow, but they do not allow for these devices to be used on any other surfaces and are impractical for most wheelchair users. Other adaptations are not easily attached and detached or are too big to conveniently store. Almost all are also very expensive.

Accordingly, there is a need in the art for an adaptive device for wheelchair users in winter climates that would increase mobility through snow and ice without sacrificing the functionality of traditional casters.

### SUMMARY

The present disclosure is directed to a traction enhancing device for a wheelchair wheel.

According to an aspect is a traction enhancement system for a wheelchair wheel that is mounted to a wheelchair frame, comprising a tooth bar assembly mounted to the wheelchair wheel such that it will rotate in a path of motion corresponding with the wheelchair wheel's rotational motion. The tooth bar assembly further comprises a mounting ring attached in laterally offset relation to the wheel; a plurality of brackets attached to the mounting ring; and a plurality of bars having a plurality of teeth extending outwardly therefrom, wherein each bar is movably attached to a respective one of the brackets. The traction enhancement system further comprises an activation assembly attached to the wheelchair frame, comprising a lever having a first end adapted for engagement by a user and a second end and selectively movable by a user between engaged and disengaged positions relative to the tooth bar assembly, a swashplate attached to the second end of the lever and positioned in the path of motion of the tooth bar assembly when the lever is in its engaged position, and positioned outside the path of motion of the tooth bar assembly when the lever is in its disengaged position.

According to an aspect is a traction enhancement device for a wheelchair wheel that is mounted to a wheelchair frame, comprising a tooth bar assembly, comprising: a mounting ring adapted for attachment in laterally offset relation to the wheel; a bracket adapted for attachment to the mounting ring; a bar having a plurality of teeth extending outwardly therefrom, the bar adapted for pivotal attachment the bracket.

According to an aspect is a method for enhancing the traction of a wheelchair wheel that is mounted to a wheelchair frame, comprising the step of moving a lever that is attached to the wheelchair frame from a first position to a second position, whereby a swashplate engages a tooth bar assembly causing a toothed bar to extend outwardly from the wheelchair wheel and radially beyond the wheelchair wheel into engagement with the surface on which the wheelchair wheel is positioned.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a perspective view of a wheelchair.

FIG. 2 is a plan view of components of a traction enhancement system, in accordance with an embodiment.

FIG. 3 is a side elevation view of a tooth bar assembly mounted a rear wheel of a wheelchair, in accordance with an embodiment.

FIG. 4 is a side elevation view of swashplate with activation lever attached to the frame of a wheelchair, in accordance with an embodiment.

FIG. 5 is a side elevation view of pikes extending radially outwardly beyond the outer diameter of a rear wheel of a wheelchair, in accordance with an embodiment.

FIGS. 6A-6C are sequential, schematic views of a wheelchair wheel rotating and a traction enhancement device providing enhanced traction to the wheelchair, in accordance with an embodiment.

FIG. 7 is a schematic front elevation view of an actuation assembly of a traction enhancement system, in accordance with an embodiment.

FIG. 8 is a schematic side elevation view of an actuation assembly of a traction enhancement system, in accordance with an embodiment.

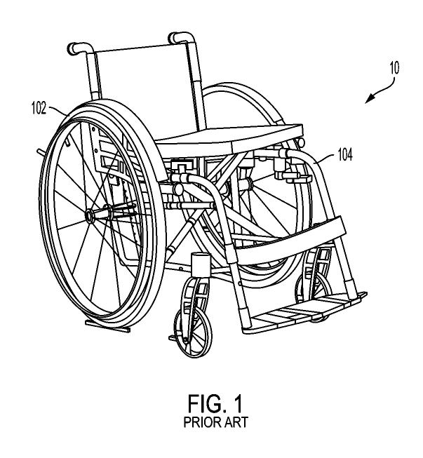

### DETAILED DESCRIPTION OF EMBODIMENTS

The present disclosure describes a traction enhancing device for a wheelchair wheel.

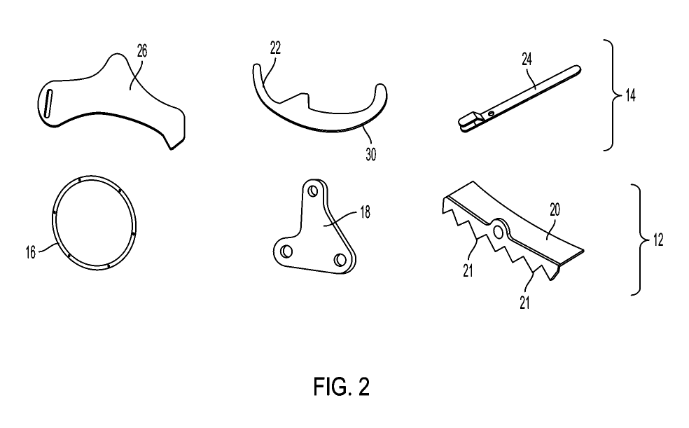

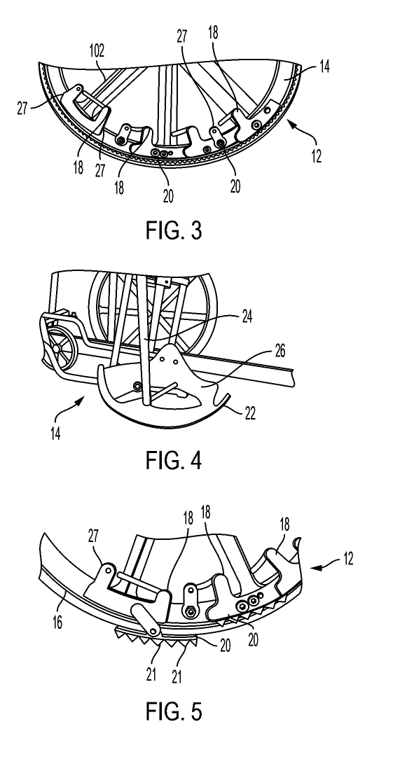

Referring to FIGS. 2-8, in one embodiment, is a traction enhancing device, designated generally by reference numeral 10, for attaching to a wheelchair 100, and more specifically a rear wheel 102 and the frame 104 of wheelchair 100. In use, a traction enhancing device 10 would be attached to each rear wheel 102/frame 104 of a wheelchair 100. Traction enhancing device comprises two primary assemblies: a tooth bar assembly 12 and an activation assembly 14. The two assemblies 12 and 14 cooperatively act with one another to enhance the traction a rear wheel 102 will get in snow/ice, as will be described in further detail hereinafter.

The components that comprise the tooth bar assembly 12 are: a mounting ring 16 that securely attaches to wheel 102, an L-shaped bracket 18 attached to the mounting ring 16, and an elongated tooth bar 20 attached to the L-shaped bracket 18 and having a plurality of wedge-shaped spikes 21 protruding therefrom. The components that comprise the activation assembly 14 are: a swashplate 22, a lever 24, and a swashplate frame 26 that attaches to the wheelchair frame 104.

As indicated, mounting ring 16 attaches to wheel 102 in laterally offset relation thereto and is positioned slightly inward from the outer diameter of the wheel 102. Mounting tabs 27 extend inwardly in spaced intervals around the mounting ring 102 and serve as anchor points for the L-shaped brackets 18. The L-shaped brackets 18 are connected to the mounting ring 16 and permit pivotal movement with a spring 29 that extends between the L-shaped bracket 18 and the mounting tab 27 permitting the pivotal movement outwardly when an external force is applied (the external force being the swashplate acting on the tooth bar 20 as will be described) and then pulling the bracket back once the external force is removed. Tooth bar 20 is attached to L-shaped bracket 18 and comprises an elongated body having a flattened upper surface of predetermined width W and a plurality of teeth/wedge shaped-spikes 21 extending downwardly therefrom. When an external force is not applied (i.e., the upper surface of the tooth bar is not engaged by the swashplate), the tooth bar is positioned inward from the outer diameter of the wheel 102; when the external force is applied (i.e., the swashplate is engaged with the upper surface of the tooth bar), the movement of the tooth bar will position the wedge-shaped spikes 21 beyond the outer diameter of the wheel 102.

When mounted to wheelchair 100, swashplate frame 26 is bolted or otherwise affixed to frame 104 in laterally spaced relation to wheel 102. Lever 24 is elongated and extends downwardly from its upper end which is positioned adjacent the arm rest 106 of the wheel chair 100 (such that it is easily handled by a user sitting the chair). Lever 24 is fastened to swashplate frame 26 at an intermediate position along its length and can pivot/rotate about the axis X-X that extends through the fastener.

Swashplate 22 is elongated, extending essentially along an axis that is perpendicular to the axis along which lever 24 extends. It comprises a curved, lower surface/cam 30, and is attached an intermediate position along its length to the bottom end of lever 24. It moves along with lever 24 so that when the lever is moved forward out of spike engagement, swashplate 22 will also rotate about axis X-X and its cam surface 30 will be moved out of engaging relation relative to tooth bar assembly 12. When the lever 24 is moved into spike engaging position, swashplate 22 will be positioned such that its cam surface 30 will be positioned in engaging relation relative to tooth bar assembly 12, as will be described hereinafter. A spring 28 extends between swashplate 22 and swashplate frame 26 to provide a bias against which the lever can be moved forward/rearward by the user into or out of spike engaging position (the spring 28 acts an over-center spring and will pull the lever out of engagement or into engagement to assist the user and limit the amount of movement of which the lever is capable.)

In terms of the numbers of tooth bar assemblies attached to mounting ring 12, it can vary depending on need. Assemblies can be mounted such that tooth bars extend essentially all the way around the wheel or in spaced intervals (such as every 90 degrees) if not needing complete gripping force. The fewer the assemblies, the lower the weight added to the wheelchair and thus the easier it would be for the user to maneuver.

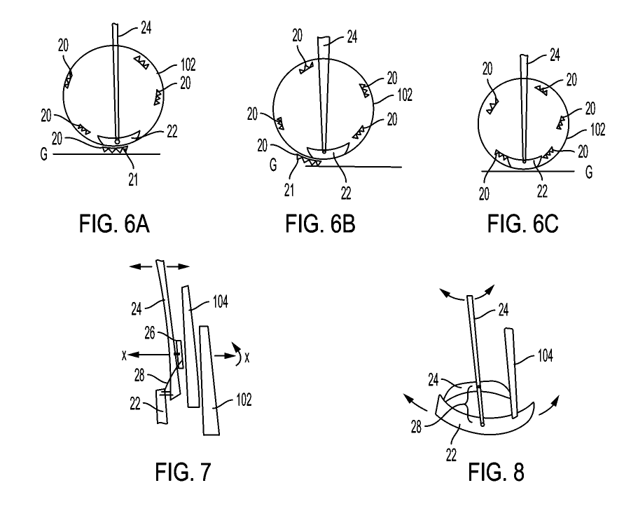

With reference to FIGS. 6A-6C, as the wheel 102 rotates, the tooth bars 20 will also move in the same rotational path of the wheel and come into and out of engagement with swashplate 22. When at the bottom of the wheel, the tooth bar 20 will be forced by the swashplate 22 to push the wedged shaped spikes 21 outside the diameter of wheel 102 and engage the ground G. The spring 29 pull the tooth bar 20 back within the diameter of wheel 102 once it is no longer engaged with the swashplate 22.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A traction enhancement system for a wheelchair wheel that is mounted to a wheelchair frame, comprising:
a. a tooth bar assembly mounted to the wheelchair wheel such that it will rotate in a path of motion corresponding with the wheelchair wheel's rotational motion, comprising:
i. a mounting ring attached in laterally offset relation to the wheel;
ii. a plurality of brackets attached to the mounting ring;
iii. a plurality of bars having a plurality of teeth extending outwardly therefrom, wherein each bar is movably attached to a respective one of the brackets;
b. an activation assembly attached to the wheelchair frame, comprising:
i. a lever having a first end adapted for engagement by a user and a second end and selectively movable by a user between engaged and disengaged positions relative to the tooth bar assembly;
ii. a swashplate attached to the second end of the lever and positioned in the path of motion of the tooth bar assembly when the lever is in its engaged position, and positioned outside the path of motion of the tooth bar assembly when the lever is in its disengaged position.

2. A traction enhancement device for a wheelchair wheel that is mounted to a wheelchair frame, comprising a tooth bar assembly, comprising:
a. a mounting ring adapted for attachment in laterally offset relation to the wheel;
b. a bracket adapted for attachment to the mounting ring;
c. a bar having a plurality of teeth extending outwardly therefrom, the bar adapted for pivotal attachment the bracket.

3. A method for enhancing the traction of a wheelchair wheel that is mounted to a wheelchair frame, comprising the step of moving a lever that is attached to the wheelchair frame from a first position to a second position, whereby a swashplate engages a tooth bar assembly causing a toothed bar to extend outwardly from the wheelchair wheel and radially beyond the wheelchair wheel into engagement with the surface on which the wheelchair wheel is positioned.
